(19) United States
(12) Patent Application Publication
(10) Pub. No.: US 2007/0094132 A1
(43) Pub. Date: Apr. 26, 2007

(54) System and method for person to person electronic fund transfer using video payphones

(76) Inventors: Vincent Anthony Waterson, Ventura, CA (US); David Sturgess, Chesterfield (GB)

Correspondence Address: Vincent Anthony Waterson, Apt 302, 369 Paseo de Playa, Ventura, CA, 93001, US

(21) Appl. No.: 11/580,964

(22) Filed: Oct. 14, 2006

Related U.S. Application Data
(60) Provisional application No. 60/730,399, filed on Oct. 25, 2005.

(51) Int. Cl. G06Q 40/00

(52) U.S. Cl. 705/39

(57) ABSTRACT

The transferring of funds using SMART cards over a network is described. A dispenser for SMART cards, connected to a data network is configured to credit SMART cards. A point-of-sale SMART card reader, connected to the data network, is configured to debit SMART cards. An account server connected to the data communication network, is configured to control the value of SMART cards. A first video payphone, having a SMART card reader, is connected to the data network and is configured to initialize a video phone call. A second video payphone, having a SMART card reader, is connected to the data network and is configured to receive a video phone call. A service operator is in communication with the first video payphone, the second video payphone and the account server. The service operator is configured to debit and credit SMART cards during the video phone call.

### CROSS-REFERENCE TO RELATED APPLICATIONS

The present Utility patent application claims priority benefit of the U.S. provisional application for patent 60/730,399 filed on Oct. 25, 2005 Linder 35 U.S.C. 119(e). The contents of this related provisional application are incorporated herein by reference.

### FEDERALLY SPONSORED RESEARCH OR DEVELOPMENT

Not applicable.

### REFERENCE TO SEQUENCE LISTING. A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to methods of money transfer. More particularly, the invention relates to a method of transferring funds from person to person electronically with the use of a video payphone.

### BACKGROUND OF THE INVENTION

Expatriate workers may be away from home for months, sometimes years, and, therefore, do not see their family for long periods of time. Overseas, Filipino workers are one of the largest expatriate work forces with an estimated 8 million workers abroad. A high percentage of these workers are women, mothers who may not see their children for months at a time. Other Asian nations, which have a significant population working overseas, include, without Limitation, India, Pakistan, and Indonesia. In North America Mexicans are the large expatriate force.

Millions of expatriate workers around the world send remittances to their relatives, friends and creditors in their home countries using services provided by international money transfer companies. Typically, the money sender takes the cash to a remittance office for example, without limitation, Western Union international, who then electronically transfers the funds to a remittance collection center in the home country where the funds, less a transmission fee, can be collected the same day or the next day the office is open.

The money transfer company typically charges a fee based on the amount transferred, which for smaller amounts such as, but not limited to, US$100 may be as high as 15% of the amount transferred. In addition the money transfer company takes a commission on the currency exchange on international transfers. It is therefore cost prohibitive for expatriate workers to send home small sums of money which may be required for an emergency or a special occasion such as, but not limited to, a relative's birthday.

A low cost method of allowing expatriate workers to electronically transfer funds internationally at a moment's notice between themselves and family members at the same time as they had visual communications between each other would provide an instant gratification not available through current technology.

Prior art includes an electronic purse that relates to the transfer of funds electronically between SMART cards using a conventional voice based telephone network equipped with an electronic terminal which is an embodiment of the electronic pulse. The electronic pulse also seeks to improve on an earlier approach, an electronic money system that proposes an electronic purse which can be connected through telephone communication means by addressing problems with the earlier approach, most notably the problem of interrupted voice communication during the transfer. The transfer of data to accomplish an Electronic Fund Transfer (EFT) on a conventional Public Switched Telephone Network (IPSTN) has to be done ‘in-band’ (i.e. within the normal 300 hz-3400 hz bandwidth of the PSTN), and therefore neither party in the transfer can communicate with each other during the “dial-up modern or fax line data transfer noise” which is experienced when a modem or fax is accidentally connected to a phone line with a voice call in progress. To attempt to overcome this problem the current art proposes a complex solution that still leaves both calling and called parties without communications during the EFT, and if a problem occurs during the transfer, the parties have no way of communicating with each other.

In the following any reference to “SMART card reader” refers to a device that is capable of reading writing or updating a SMART CARD, and reference to “Central Database” is a database of information held on a computer system at the Network Central Office.

A known approach that seeks to make it easy to transfer funds electronically between individuals is an approach that provides for a method for making a person-to-person electronic fund transfer using a telecommunications device. This approach enables a user with a cell phone to electronically transfer funds from the sender's own bank account to the recipient bank account so the recipient can retrieve the funds from an ATM machine using a debit card linked to the account. The disadvantage of this approach is that this method requires both the sender and the recipient to have bank accounts and the same banks also need to have in place on-line banking services. This method also requires the users to be registered with a central server, which processes the transaction. In the case of expatriate workers, many low paid workers may not have bank accounts, or if they do, their bank account maybe overdrawn so if they have to make a small emergency payment the bank may simply use the incoming funds to reduce or pay off the overdraft.

Another system, which enables the electronic fund transfer between two individuals, is a value transfer system. An embodiment of the value transfer system is the ability to transfer funds electronically between two persons each with SMART cards. The disadvantage of this approach is that it requires both users to possess SMART card reader devices containing software provided for by the approach and have these connected to a communications network to facilitate the electronic transfer. To make this approach work in countries where many expatriate workers are based would require the establishment of a dealer network to import and sell the card readers, something that would be prohibitively expensive. Expatriate workers would also need to have access to an internet access point to connect the SMART card reader, something that may be difficult to arrange at the work location.

In view of the foregoing, there is a need for a device that provides video communication between two parties and provides a way to transfer monetary funds between the two parties without the use of bank accounts and without losing the video communication. This device also needs to be readily available to the groups of people who will benefit most from their use.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary videophone call and Electronic Fund Transfer apparatus, in accordance with an embodiment of the present invention;

FIG. 2 is a detailed view of an exemplary videophone showing a location of a SMART card reader, in accordance with an embodiment of the present invention;

FIG. 3, FIG. 4. FIG. 5, FIG. 6, FIG. 7, FIG. 8, and FIG. 9 are flowchart diagrams illustrating an exemplary process for an EFT made during a videophone call and how a SMART card is charged for both the videophone call and the EFT; and

FIG. 10 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a transferring of funds utilizing public access telecommunications terminals is described.

In one embodiment, two video payphones are identified. A video phone call is established between the two video payphones. Each of the video payphones is simultaneously connected to a central database providing secure EFT transfers. A SMART card is associated with each of the video pay phones. During the video phone call an EFT transaction is written to the SMART card (optional) and the Central Database (optional). Value is debited from one of the SMART cards and credited to the other SMART card.

In another embodiment of the invention, the transferring of funds using SMART cards over a telecommunications network is described. A SMART card dispenser which is connected to a data communication network is configured to dispense SMART cards. SMART cards may also be manually dispensed by an authorized merchant and then registered on the Central Database. A point-of-sale SMART card reader which is connected to a data communication network. The point-of sale SMART card reader is configured to debit a SMART card. A merchant account server connected to the data communication network, in communication with the dispenser and the point-of-sale smart card reader, is configured to control the value of SMART cards. A video phone call uses the telecommunications network. A first video payphone connected to the data communication network and the telecommunications network, is configured to initialize a video phone call. A first SMART card reader connected to the first video payphone. A second video payphone connected to the data communication network and the telecommunications network is configured to receive a video phone call. A second SMART card reader connected to the second video payphone. A service operator server connected to the data communications network, is in communication with the first video payphone, the second video payphone and the merchant account server. The service operator server is configured to debit and credit SMART cards during a video phone call for transferring the funds.

In yet another embodiment, a computer program product residing on or being distributed across one or more computer readable mediums having a plurality of instructions stored thereon which, when executed by one or more associated processors, cause the one or mole processors to identify two video payphones. One or more processors establish a video phone call between two video payphones. One or more processors connect each of the video payphones to a central database providing secure EFT transfers. One or more processors write an EFT transaction number to SMART cards associated with each of the video payphones. One or more processors debit a value from one of the SMART cards during the video phone call. One or more processors then credit the value to another of the SMART cards during the video phone call.

### DETAILED DESCRIPTION OF THE PREFERRED EMBODIMENTS

The present invention is best understood by reference to the detailed figures and the description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, without limitation, it should be appreciated that those skilled in the art will, in light of the teachings of the present invention, recognize a multiplicity of alternate and suitable approaches, depending on the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

An aspect of preferred embodiments of the present invention is to enable expatriate workers around the world to have an instant gratification moment with their family and/or friends in their home country by being able to see each other and to send money to them at the same time. The reason many expatriate workers are working abroad is to support their relatives in their home country, therefore being able to see their relatives and watch the reactions of their relatives as they receive money is priceless.

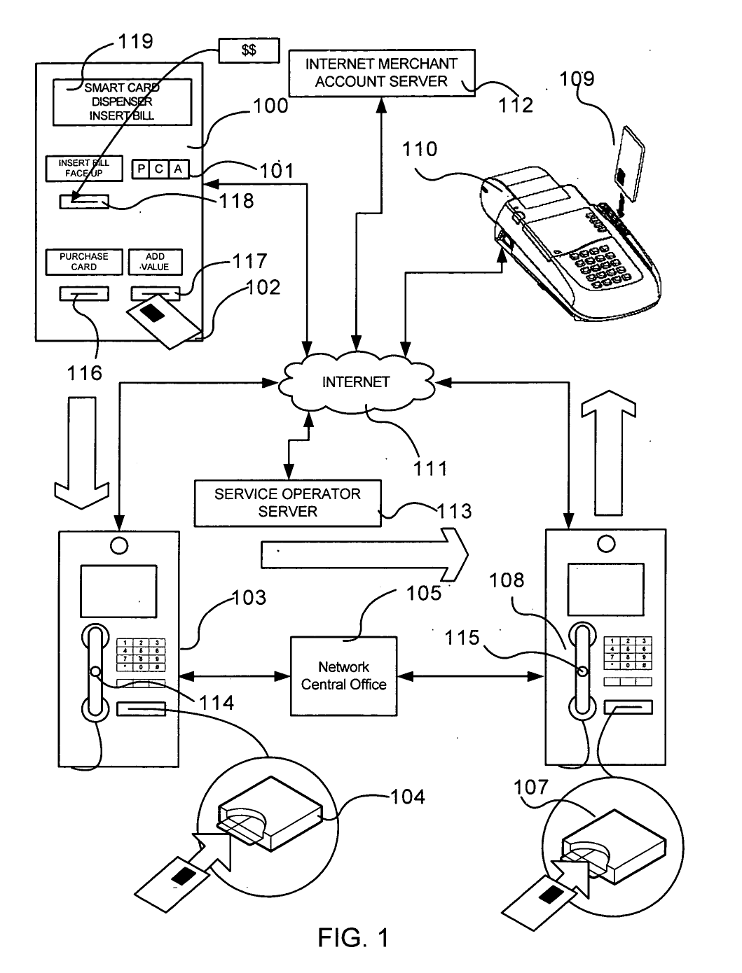

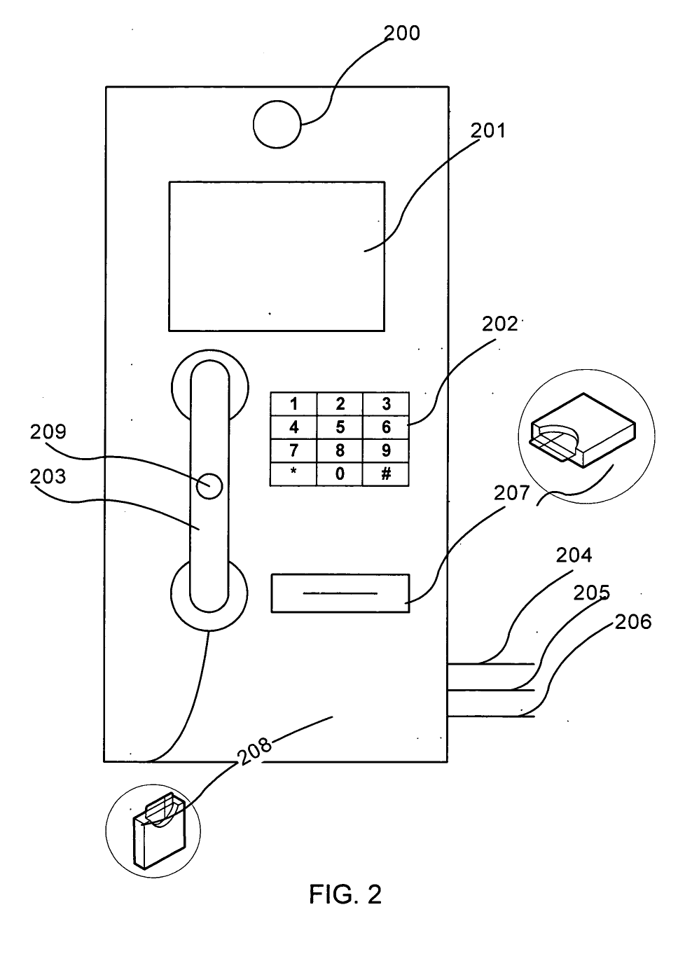

In the embodiments illustrated by way of example in FIGS. 1 and 2, the apparatus comprises a number of interrelated parts that together form a complete system for making videophone calls between two video payphones and for the simultaneous electronic transfer of fluids between SMART cards during the videophone call. The component parts include, without limitation, a SMART card dispensing machine, two video payphones equipped with SMART card readers and fingerprint scanners, and a Point-Of-Sale SMART card reader.

FIG. 1 illustrates an exemplary videophone call and Electronic Fund Transfer apparatus, in accordance with an embodiment of the present invention. In the present embodiment, there is provided a SMART card dispensing machine 100 that has a bill acceptor slot 118 and optionally a Debit/Credit card acceptor slot where the user can insert currency notes of various denominations and a screen 119 which displays the value of the notes inserted and a keypad 101 which allows the user to purchase a new SMART card or add value to an existing SMART card. When a new card is required the user inserts the currency notes in the bill acceptor slot 118 and presses the Purchase Card button on keypad 101. The dispensing machine 100 reads the face value of the note and encodes the value onto the microprocessor memory of one of a stack of SMART cards stored inside and then dispenses through the slot 116 a SMART card 102 containing the value purchased. When a customer wishes to add value to an existing card the user inserts the card in slot 117 then inserts the currency notes to the value required in bill acceptor slot 118 and presses the Add Value button on keypad 101 which ejects the SMART card 102 containing the added value through slot 117. In an embodiment of the present invention, an algorithm is also stored on SMART card 102 that can convert call-charging information provided by the communications network operator into charge per minute value debited from the card during a video call. The IMA server converts all non-US$ transactions to US$ at the prevailing daily currency exchange rates issued by US Federal Reserve Bank.

In the present embodiment, the user may use SMART card 102 in a public video payphone 103 to make a video phone call connected through a telecommunications system with a network Central Office 105 to a second public video payphone 108. Public video payphones 103 and 108 are equipped with SMART card readers 104 and 107, respectively that incorporate software, which is a component of preferred embodiments of the present invention. In the present embodiment, SMART cards are used to pay for the cost of the video call and to enable the transfer of value between two SMART cards during the video call. When the value has been transferred electronically from a SMART card inserted in card reader 104 to a SMART card in card reader 107, the user can retrieve a SMART card 109 from card reader 107 and take SMART card 109 to a retailer or money broker with a Point Of Sales SMART card reader 110. Here, SMART card 109 can be inserted into SMART card reader 110, and value units are debited from SMART card 109 in exchange for goods, services or cash. SMART card dispensing machine 100, video payphones 103 and 108, and Point-of-Sale SMART card reader 110 are connected through a public Internet 111 to an Internet Merchant Account (IMA) Server 112 and to a Service Operator Server 113. This enables a history for the life of each SMART card to be maintained in order to enable EFT transactions to be completed securely and detect attempted fraudulent use of SMART cards. In the present embodiment, the handsets of video payphones 103 and 108 are also provided with fingerprint scanners 114 and 115 to facilitate positive verification of video callers for example, without limitations to financial or government institutions who require additional authentication. Alternate embodiments may not include fingerprint scanners or may only include an fingerprint scanner on some of the video payphones.

FIG. 2 is a detailed view of an exemplary videophone with a SMART card reader, in accordance with an embodiment of the present invention. In the present embodiment, there is provided a public access video payphone that is mounted in a vertical position on a wall or a supporting stand so that a user can typically stand in front of the videophone to make the call. In alternate embodiments, the video payphone may rest on a counter or table so that the user may sit to make the call. In the present embodiment, the video payphone comprises a video camera 200 that can be manually adjusted by the user to allow for user height. The payphone has a telephone handset 203 for sending and receiving audio during a video call. In typical use of the present embodiment, the calling party first lifts handset 203 and inserts a SMART card in a SMART card reader 207. The user then dials the called party number using a keypad 202. Typically, to receive a video call the user places handset 203 on-hook and then lifts handset 203 off-hook when the video phone rings to answer the call.

The present embodiment is located in a public place such that video camera 200 in the videophone is not pointing towards nor has in its field of view a television set or television monitor displaying moving pictures. The display of moving pictures in the field of view of video camera 200 may cause the codec in the video payphone to attempt to process the moving picture in the background in addition to the user picture and degrade the picture quality of the videophone call. The presence of a television set in the field of view of video camera 200 is the visual equivalent to installing a regular payphone close to a source of noise such as, but not limited to, a radio playing loud music or a PA system.

In the present embodiment, the video payphone has an LCD screen 201, which displays the user picture from the camera and, during a videophone call, the received picture of the opposite communicating user. In the present embodiment, screen 201 is typically 10 inches in size, but in alternate embodiments, screen 201 may be a variety of sizes. Also, in alternate embodiments, the screen may be a type of screen other than an LCD screen such as, but not limited to, a rear projection screen or a plasma screen. In the present embodiment, when a PIP on/off key of control keypad 202 is depressed, screen 201 presents a minor frame at one corner of screen 201 and displays the self-picture taken by camera 200. Also, when a monitor/PIP key is depressed in this state, screen 201 displays the self-picture on the entire surface of screen 201, and when the key is depressed again, the display of screen 201 returns to its usual state and displays the picture of the opposite communicating side on the whole surface of screen 201. Optionally, when a video call is not in progress, screen 201 can display television commercials stored on a video recorder 208, which is deactivated when a SMART card is inserted into SMART card reader 207. There is also provided on handset 203 a fingerprint scanner 209, which may be used to facilitate positive verification of video callers for transactions that require additional authentication such as, but not limited to, financial or government institutions.

In the present embodiment, a comprehensive sequence of instructions is programmed into a micro-processor controller in the video payphone to control the operation and the interaction between SMART card reader 207, the SMART card, the telecommunications system used to provide the communications between two video pay phones and the SMART card reader at the other video payphone connected during the video call.

In the present embodiment, the video payphone is typically located in a public place. This enables commercials to be shown on screen 201 that can generate additional revenue for the operator of the network when no video calls are in progress. However, in alternate embodiments, the video payphone may be located in a private or semi-private location.

In the present embodiment, the video payphone has a multi-voltage power supply adaptor 204 to enable power to be provided to components such as, but not limited to, camera 200, screen 201, SMART card reader 207, and video recorder 208. The videophone can be connected to different networks through different means such as, but not limited to, an ISDN (Integrated Switched Digital Network) network through a connector 205 or an IP (Internet Protocol) network through a connector 206. Connector 206 also permits a Personal Computer to be connected to the videophone control system to change configuration parameters or download new operating software. When the video payphone is connected to an ISDN network through connector 205, the videophone is also connected through connector 206 to the Internet so that the video payphone can exchange data with an IMA server.

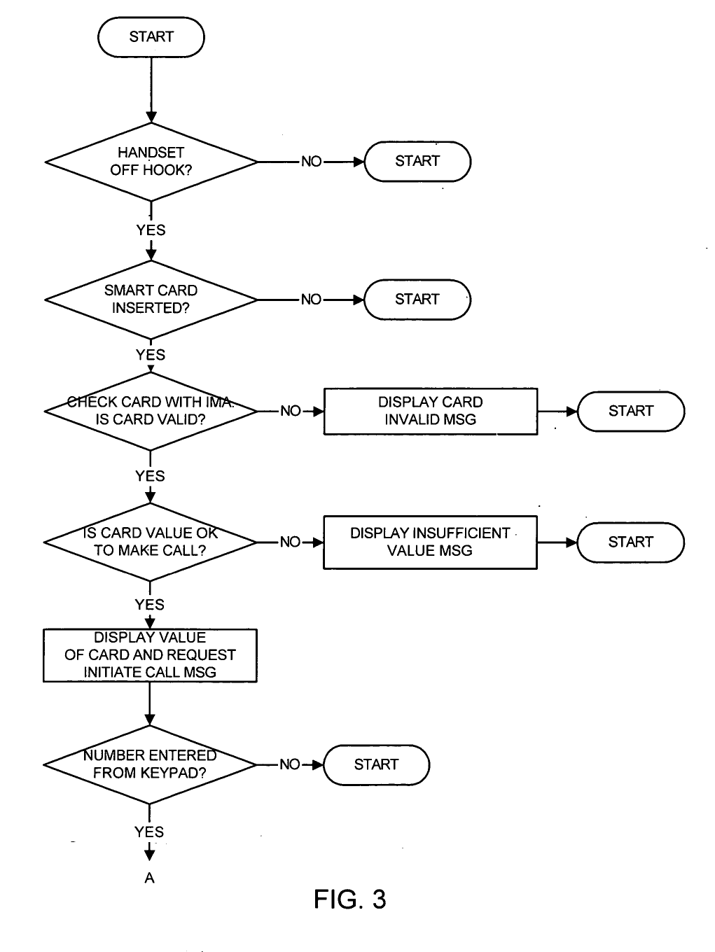

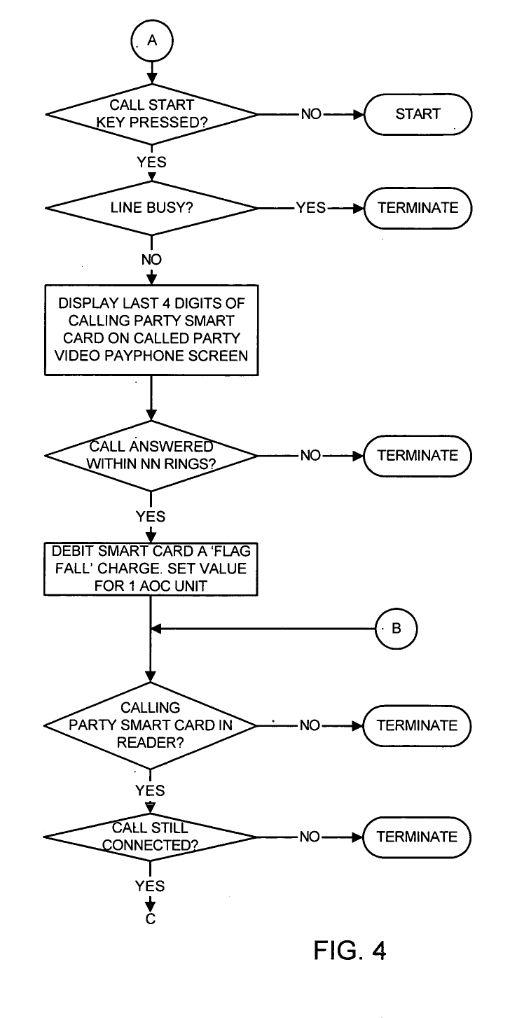

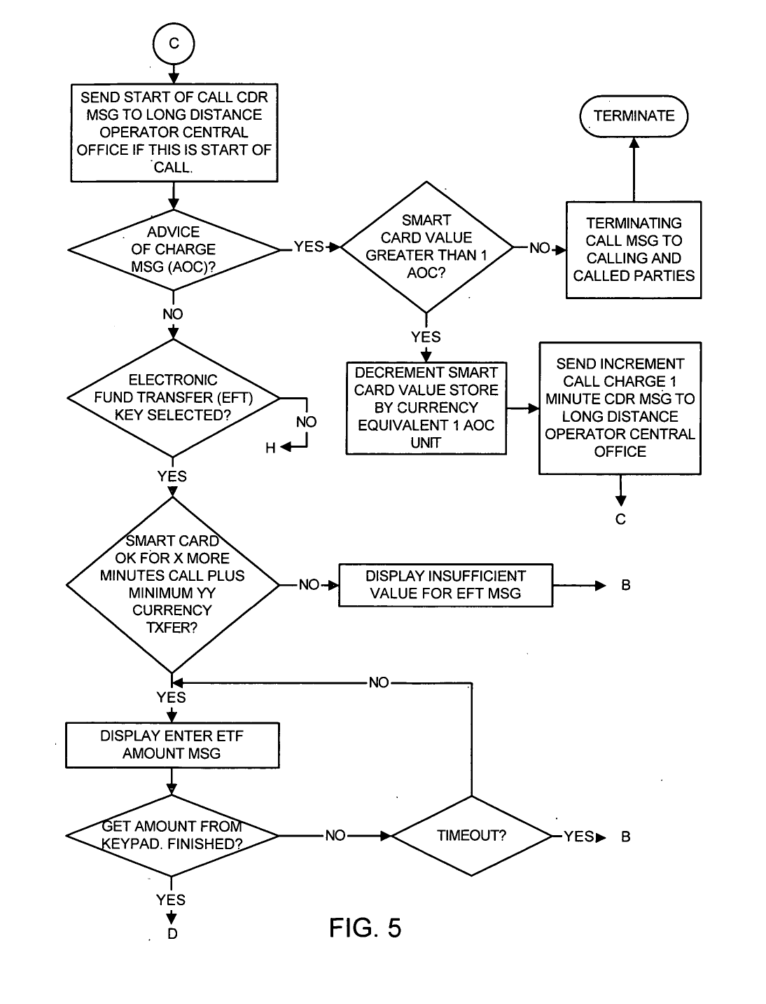

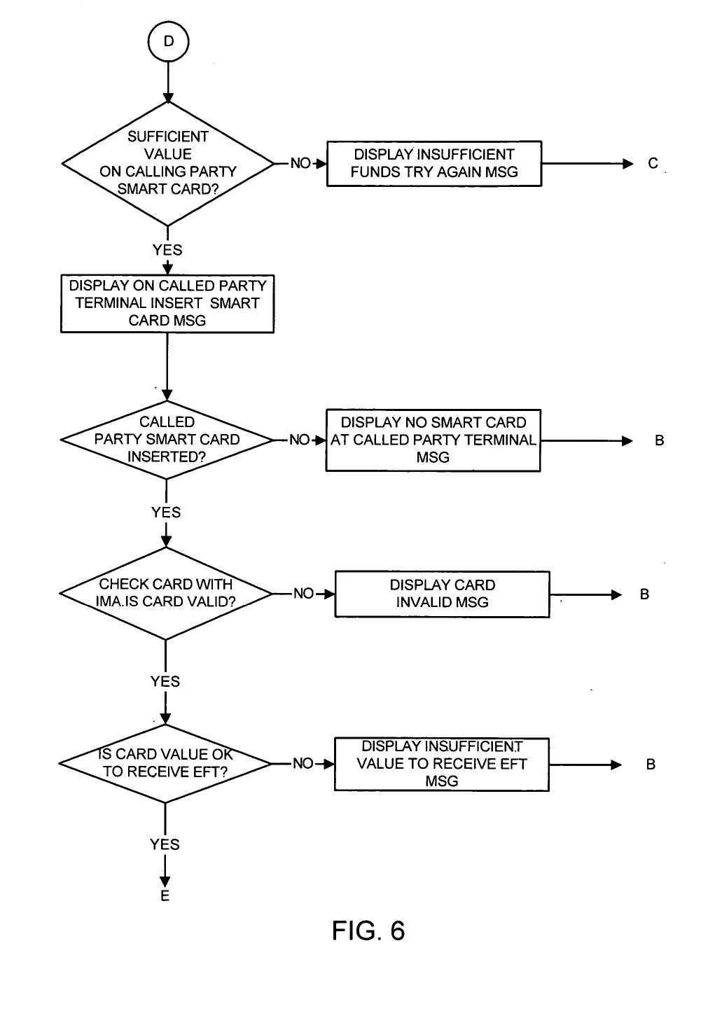

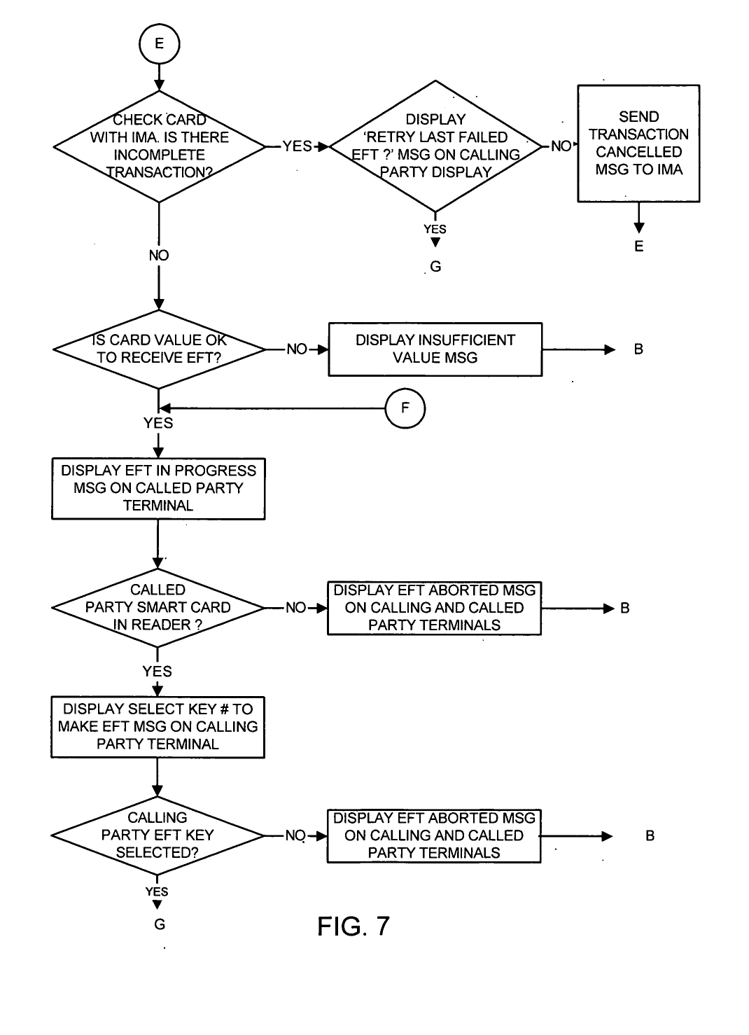

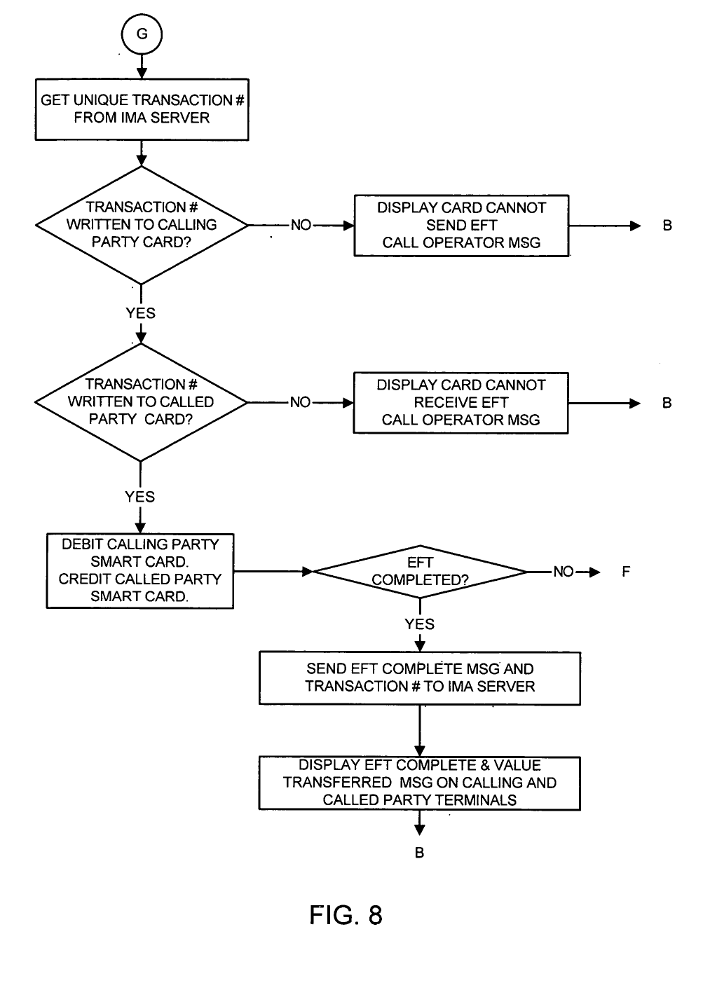

Various illustrative embodiments of the function and operation of the present invention to be controlled by a sequence of instructions issued by a microprocessor in the SMART card reader are described and shown in detail by way of example in the flowcharts shown in FIGS. 3-6. If the telephone handset is lifted off-hook the process flow is as described at the “start” point. If a SMART card is inserted, the process flow is initiated according to the illustrative embodiment, wherein a SMART card is read by the SMART card reader to determine if it is valid and has sufficient value stored to make the videophone call.

In an embodiment of the present invention the SMART card reader monitors the keypad activity and the selection of a call start key, detects if the line of the called party is busy, communicates with the IMA server to verify the SMART card is valid, and starts a billing process once the call is connected.

The instructions programmed in the SMART card microprocessor in the present embodiment debit a ‘flag fall’ charge (charge per connection) once the call is connected. The microprocessor then detects AOC (Advice Of Charge) messages periodically by the communications network Central Office controlling the call and converts the AOC messages into instructions to debit the SMART card with a per minute call charge determined by the charge per minute algorithm programmed into the SMART card at the time of purchase. In the present embodiment, the AOC messages are detected every six seconds. However, in alternate embodiments AOC messages may be detected at a variety of time periods.

The SMART card reader is programmed to send a Call Detail Record (CDR) message to the long distance operator of the Central Office connecting the video call through the telecommunications networks at the start of the call and periodically thereafter until the call is terminated. In the present embodiment the CDR messages is sent to the operator every-minute. However, in alternate embodiments the CDR messages may be sent at a variety of time periods. The CDR message contains the SMART card reader serial number which identifies the location of the video payphone and the PIN number on the SMART card that can be used for fraud prevention checks and other network management functions.

In the present embodiment, the software continually monitors for the presence of the SMART card in the SMART card reader and immediately terminates the call if the SMART card is removed from the SMART card reader. Alternate embodiments may allow the call to continue if the SMART card is removed from the SMART card leader. In the present embodiment, the value remaining on the SMART card after each AOC debit is also monitored. If there is less than one AOC period remaining on the SMART card, a message is sent to the displays of both the calling and the called party video payphones advising that the call will terminate within one AOC period, one minute in the present embodiment.

The software continually monitors for the selection of a key designated for making an Electronic Fund Transfer (EFT). In the present embodiment, this is the # key. However, in alternate embodiments other keys may be designated for making an EFT, and in other alternate embodiments, there may be a specific key to perform an EFT, for example, without limitation, an EFT key or a $ key. When this key is selected, the software determines if the SMART card has sufficient value to both continue paying for the call for a minimum additional period and also have sufficient minimum EFT value. In the present embodiment, the minimum additional period is two minutes, however, in alternate embodiments other time periods may be used so long as the time period is long enough to complete an EFT. Also, in the present embodiment, the sufficient minimum EFT value is set at US$5, however, alternate embodiments may have no minimum values or various alternate minimum values including, without limitation, alternate amounts and alternate currencies. In the present embodiment if there is insufficient value on the SMART card, an insufficient funds for EFT message is displayed on the calling party screen and the EFT is barred. If the SMART card has sufficient EFT funds stored, the software sends a message to the remote SMART card reader and instructs the video payphone to display a message on the remote video payphone display requesting the called party to insert a SMART card into the SMART card reader. If the called party does not insert a SMART card into the card reader within a predetermined time, the EFT is cancelled. If the called party inserts a SMART card into the SMART card reader, the software checks that the SMART card is valid and if the called party SMART card reader advised the calling party SMART card reader that the EFT may continue.

The calling party enters from the keypad the amount to be transferred. If this amount is more than the value available on the calling party SMART card for an EFT, the user is asked to retry. When an acceptable amount is keyed in the software checks that the calling party SMART card is still inserted in the card reader.

In the present embodiment, the software ensures the security of the EFT by assigning, a unique transaction number from the IMA server for each transaction, and records the value of each successful transaction together with the PIN numbers of the two participating SMART cards on the IMA server. This enables an incomplete transactions for example, without limitation, due to a network failure, to be completed automatically the next time the same two SMART cards are connected through a communications network. The present embodiment also checks for fraudulent use of the SMART cards by comparing the value stored on the SMART card with the original and subsequent prepaid purchases at authorized SMART card dispensers along with previously recorded usage for video calls and EFT. The software is also constantly verifying the presence of the SMART cards in the SMART card readers at both ends and debits the calling party SMART card and credits the called party SMART card in such a way that if there is a malfunction with the called party SMART card, for example, without limitation, premature extraction of the SMART card during an EFT, or the call is terminated for whatever reason the calling party SMART card will not be debited the EFT value until the software confirms that the called party SMART card has been credited. During the EFT, the software will continue to debit the calling party SMART card for call charges, however, provision is made that sufficient call charge minutes are kept in reserve to pay for the call during the EFT. When the EFT is complete, a message is sent to the called party display advising the amount transferred and authorizing the SMART card to be removed. The callers can then continue with the videophone call.

An embodiment of the present invention provides for the installation of public video payphones at public places such as, but not limited to, shopping malls and airports initially in the USA, Mexico and many countries in the Asia/Pacific region. However, these video payphones may be installed in virtually any country, and in alternate embodiments these videophones may be installed non-public places such as, but not limited to, workplaces or offices. In the present embodiment, these videophones are positioned as to avoid extraneous signals, which would degrade the quality of the videophone call. To avoid the sources of extraneous signals, videophones generally are not placed where moving pictures on other television sets will be in the field of view of the videophone camera. Moving pictures in the field of view of the videophone camera may result in the videophone codec attempting to process more information than the limited movement of the “head and shoulders” caller images that the videophone in the present embodiment is designed to handle.

In the present embodiment, a list of video payphone numbers and their locations are available on an Internet web site so that users may find this information. Video payphones are equipped to work on an ISDN (Integrated Switched Digital Network) or on an IP (Internet Protocol) network. The present embodiment of the video payphone operates on ISDN networks Supporting ITU-T H.320 at 128 kbps and 15 fps. The present embodiment of the video payphone can also operate on an IP network Supporting ITU-T H.323 standard at up to 384 kbps and 30 fps and can connect to the newel SIP (Session Initiated Protocol) networks through commercially available gateways. In the present embodiment. ITU-T.120 protocol is used for data transfer on videophone calls to make the Electronic Fund Transfer during and without interrupting the videophone call, however alternate protocols may be used in alternate embodiments.

Those skilled in the art will recognize that technology exists to upgrade the data rate on ISDN from 128 kbps 15 fps to 384 kbps 30 fps if market conditions will support the extra cost of the upgrade. It is expected that the video payphones deployed in more technological countries such as, but not limited to, the USA may be connected to an ISDN network whereas those in less technological countries, such as, but not limited to, countries in Asia may be connected to an IP network. Video payphones connected to ISDN and IP can communicate with each other via ISDN/IP gateways, which are already established in the market place and known to those skilled in the art. ISDN networks typically support the European Telecoms Standard Institute ETSI ETS 300 178 protocol Advice of Charge Duration (AOC-D) signaling for billing. Commercially available gateways now support reception of European ISDN (Euro ISDN) signaling and convert the AOC-D messages into SIP Info (during a call) and Bye (end of a call) messages using a proprietary AOC SIP header.

When a video payphone is used on an ISDN network, the payphone will also be connected to the public Internet through its IP port so that the equipment can communicate with management facilities, which are a component of an embodiment of the present invention. In these embodiments, management facilities include, without limitation, a telecommunications network Central Office, which can switch videophone calls between two video payphones and provide signaling to video payphones, which can be used for billing for the duration of a video call.

In the present embodiment, comprises the integration of software into the existing video payphone equipment, which can be ported to any ISO 7816 compatible SMART card readers, which enables the existing SMART card reader in the video payphone to be used to transfer funds electronically between two video payphone SMART cards during a video call. In the present embodiment, the SMART card itself is an integrated circuit chip card that can store value, which can be allocated for services such as, but not limited to, prepaid video call minutes and the transfer of electronic funds. Also, the SMART card reader is not only able to dynamically allocate the value stored on the SMART card inserted into the SMART card reader, but it is also able to use that value to pay for the call and to complete any electronic transfers requested by the user. The SMART card reader can detect billing signals from a telecommunications network Central Office and can convert those signals into data representing incremental time charges for the video call and writes this data to a SMART card inserted in the video payphone card reader.

The present embodiment also provides for SMART card dispensers to be located in all countries where the video payphones are located. In the present embodiment, a dispensing machine is programmed with an algorithm that can convert the value of the currency inserted in the machine to purchase the SMART card and can convert the currency amount into data representing prepaid video call minutes and writes the same data to the SMART card before the SMART card is dispensed by the machine. SMART card dispensers are connected to the Internet and provide real time information to the network operator such that the operator knows how much cash has been deposited into the dispensers for accounting purposes. A calling party uses cash to purchase a SMART card from a card dispenser. For example, without limitation the calling party may purchase a SMART card with a value of $110. The called party also purchases a SMART card with cash but only sufficient to enable the SMART card for use, for example, without limitation, $5. The called party SMART card enablement charge includes the cost of purchasing the physical SMART card and the use of the SMART card dispensing machine. When the calling party, for example, without limitation, an expatriate worker, wishes to make a videophone call and transfer funds to a called party, for example, without limitation, a relative in the home country, the calling party alerts the called party so both parties can be present at the same time at a public video payphone. The calling party may alert the called party of the call a variety of ways, for example, without limitation, using SMS, text messaging, e-mail, traditional phonies, cellular phones, etc.

In typical use of the present embodiment, the calling party makes a video payphone call by inserting a SMART card containing stored value units into the SMART card reader in the video payphone and then dialing the number of the distant video payphone which, like a regular phone, rings to alert the other person of the call. In the present embodiment, once the SMART card is inserted in the video payphone and the handset is off the hook, the system connects the videophone through the public Internet to the server of the Internet Merchant Account (IMA) provider acting as the financial clearinghouse for the network. The IMA server checks against the server's database of SMART card purchases from dispensing machines that the SMART card is valid and has sufficient prepaid calling minutes stored to make the video call. In the present embodiment, the IMA settles the financial transactions between the parties involved in the transaction and can also detect attempted fraudulent use of the network.

The present embodiment also provides for a call scheduling procedure whereby the calling party messages the called party prior to the call with the last 4 digits of the calling party SMART card printed on the card. When the calling party uses the videophone, the program instructs the last 4 digits of the calling party SMART card to be displayed on the screen of the called party videophone so that the recipient waiting in a public place to receive the video call will know that the video call is for the recipient

Upon hearing the video payphone ring, the called party lifts the handset on the video payphone, which completes the call connection so that both parties can both hear and see each other. In the present embodiment, the video payphone has a Picture in a Picture (PIP) facility so that the calling party can see themselves in a small picture within the full screen video image of the called party and the called party can see themselves in a small picture in the full screen video image of the calling party. The PIP enables the video payphone user to ensure correct position in front of the video payphone camera. In the present embodiment, the video payphone call may be at a video frame rate of 15 fps and a transmission data rate of 128 kbps or a video frame rate of 30 fps and a transmission data rate of 384 kbps. Alternate embodiments may use other frame rates and transmission data rates depending on the equipment. The calling party is charged in billing increments, increments of one minute in the present embodiment, for the duration of the call with a higher charge for higher data rate calls. Higher data rates and frame rates provide for a higher quality picture, however tests that have been conducted show that the 15 fps frame rate provides a quality of video that is acceptable to most people. In the present embodiment, the video payphone has a 10-inch LCD screen that provides an image with sufficient detail. In alternate embodiments the screen may be a different size or a different type of screen. In the present embodiment, the SMART card reader software can detect an Advice of Charge Duration (AOC-D) or similar signal generated by the communications network periodically to decrement the value of the SMART card inserted by the calling party in the video payphone by a fixed amount every billing increment, commencing with the first received AOC-D signal received. The SMART card reader is able to debit from the SMART card the value stored after detecting the number of AOC messages, which measure the number of billing increments of the video call in progress. The SMART card reader can also generate and write to the SMART card an AOC end of call message if the SMART card is removed from the reader before the AOC end of call message is received.

In the present embodiment, prepayment may be made by deducting a ‘flag fall’ (minimum connection fee) amount when the SMART card is inserted into the video payphone and continuing to deduct new amounts as the degree of service pre-purchased is used. This enables the network operator to receive full value for service in the event of premature SMART card withdrawal by the cardholder. If the SMART card is prematurely removed from the SMART card reader while the call is in progress, the call will terminate immediately, and the calling party SMART card will be debited the last recorded incremental charge plus a ‘flag fall’ charge.

In the present embodiment, a Call Detail Record (CDR) message is sent from the calling party video payphone at the start of the call and periodically thereafter to the long distance communications operator Central Office, which will identify the location of the calling SMART card reader and the PIN number on the SMART card. In the present embodiment, the CDR messages are sent every minute, however, in alternate embodiments, CDR messages may be sent at various the periods. The CDR message contains the serial number of the SMART card reader and the PIN number of the SMART card. In the present embodiment, the network charge for calls is based on a flat fee regardless of destination, therefore the long distance operator only needs to identify that the call is being originated from a video payphone belonging to the video payphone network supporting the present embodiment to be able to determine the charge. In alternate embodiments charges may be dependent on various factors, for example, without limitation: calls may be based on the distance of the call, or there may be additional charges for calls to certain countries with limited technological resources.

In the present embodiment, during the video payphone call, the calling party may initiate an Electronic Fund Transfer (EFT) from his/her SMART card to the SMART card of the called party by pressing a designated key, for example, without limitation, the # key, to gain access to the software routines. In the present embodiment, the software checks the balance on the SMART card in the video payphone SMART card reader, and, after making provision for additional call charges to pay for the continuation of the videophone call during the EFT, for example, without limitations two minutes, the software displays on the video payphone screen the maximum amount of currency that can be transferred to the remote SMART card. In the present embodiment, the software inquires the caller as to the amount of funds he/she wishes to transfer. Once the value amount is entered, the software sends a text message using an implementation of the T.120 protocol to the screen of the remote video payphone. The text message asks the called party to insert a SMART card in the video payphone and press a key once this action has been taken. When the called party presses the key to confirm the card has been inserted, the software then checks for the presence of the SMART card by writing a test message to the remote SMART card and then attempting to read this test message back to determine that this is a valid SMART card. If the card is not valid, the calling party is advised by a text message on the screen that the transfer is aborted. If the SMART card is validated, the software asks the calling, party to use the keypad to enter the amount to be transferred and an end of message button, for example, without limitation, the * key. The SMART card reader allows for the writing of data from the calling party card to the called party card through the telecommunications network such that the calling party card is debited and the called party card is credited with the same value thereby completing an EFT. In the present embodiment, the SMART card reader can also prevent the debit of value from the calling party card before the same value is added to the called party card. This protects the calling party in the case that the transfer process is interrupted, for example, without limitations due to termination of the video call during the transfer or the premature removal of the called party card from the card reader during the value transfer process between the two cards.

The present embodiment makes provision for the interruption of the EFT due to factors such as, but not limited to, communications link failure, premature removal of SMART cards from the card readers or attempted fraud by registering a transaction number on the IMA server through the video payphone connection to the Internet. Once this action is completed, the software debits the calling party SMART card with the amount and writes the amount to the called party SMART card. The microprocessor is programmed to preserve the last valid data write instruction in the event that the called party card is prematurely removed from the SMART card reader during any video call billing or EFT process. In the event there is an interruption to the EFT, the next time that a video call is made using the same two cards the IMA server will recognize the incomplete transaction and automatically attempt to complete the EFT transaction. The SMART card reader is programmed to get a unique EFT transaction number from the IMA server through the internet connection and to register with the IMA the amount transferred between the two SMART cards, identified by their unique PIN numbers. The SMART card reader then uses this information to be able to automatically complete an interrupted EFT session the next time the same two SMART cards are connected through a communication link or to determine if either SMART card is being used fraudulently in which case the EFT is aborted.

The called party who has successfully received the EFT can remove the SMART card from the video payphone at any time. When the video call is completed, the called party can then use the SMAR card at any participating retailer who has a Point-of-Sale SMART card reader to purchase goods or services. Additionally, the called party can take the SMART card to a participating moneychanger to receive cash.

The video payphone network operator will establish an Internet Merchant Account (IMA). The IMA servers collect and analyze data from a plurality of SMART card readers in SMART card dispensers, long distance telecommunications operator video call CDRs, retailer Point-of-Sale card readers and the video payphone network operator and make value settlements between all parties. Retailers and moneychangers participating in the network also establish IMAs with the same IMA provider. Retailers or money exchangers redeeming the value stored on the SMART card for goods or services do so by swiping the SMART card through a Point of Sale (POS) card swipe, which transfers the value from the SMART card to their IMA. In the present embodiment, SMART card readers connected through a telecommunication network to a valid IMA server are able to debit value from the SMART card.

In the present embodiment, the SMART Card dispensers that accept and store cash are connected to the internet and report real-time to the network operator the amount of cash stored in the dispenser since the last emptying by the authorized operator. This is accomplished by the microprocessor. The microprocessor is programmed to log a record of each transaction through a telecommunications network to a valid IMA server such that the network operator has a real-time record of the value of cash collected at a plurality of SMART card dispensing machines. The SMART card dispensers are operated and maintained by a local operator, and this operator will collect the cash periodically from the SMART card dispensers and, after deducting commission due, remit electronically the funds collected. In the present embodiment, the dispensing machine microprocessor is programmed to allow value units to be written from a SMART card reader connected through a telecommunications network to a valid IMA server to a SMART card located in the SMART card dispenser.

The network operator using a system according to the present embodiment receives payment for the video call through the measured time increment charges and for the EFT through a charge levied on each transaction completed through the IMA. Typically, the total charge for the fund transfer will be not greater than 5% of the amount transferred including a flat transaction fee, for example, without limitation, US$1 per transaction. In alternate embodiments, the charge for the fund transfer may be greater than 5% of the amount transferred, and there may be various transaction fees for alternate embodiments. In the present embodiment, the recipient of funds generally should keep a minimum balance on the SMART Card, for example, without limitation, US$5, to keep the SMART card valid. This is additional revenue for the network operator. In alternate embodiments SMART cards may be programmed so that they remain valid in the case that the SMART card has a zero balance.

Embodiments of the present invention are preferably based on using public video payphones so the calling parties and the called parties do not have to purchase any equipment or have a bank account to make the transfers.

Preferred embodiments of the present invention make the EFT during the videophone call without interrupting the video or audio components of the call.

Preferred embodiments of the present invention permit anonymous fund transfers between SMART cards as the two parties to any transaction are not identified at any stage of the transaction. This is a factor that makes the service very attractive to expatriates who, for personal reasons, may not wish to disclose the transfer to third parties.

Preferred embodiments of the present invention are contemplated to appeal to expatriate workers who may find solace in spontaneous video communications and gifting to relatives in their home country. Also, the video element of the communication implies that the calling party can see the called party, and this greatly reduces the risk of fraud, which would be present if the EFT was performed between computers or over a regular phone service providing only audio communications.

Preferred embodiments of the present invention utilize an application that makes existing video payphone more useful because EFT is generally “a must have” facility for expatriates, whereas a video call is a “nice to have” facility. The EFT embodiment has the ability to make the video payphone as valuable to expatriates as an ATM is to the general public.

The preferred embodiment enables the network operator to partner with Telephone Companies around the world to install video payphones in public places including, without limitation, shopping malls, airports and other expatriate meeting points, thereby making videophones with EFT capabilities available for use by a large number of expatriate workers and other users around the world.

FIG. 3, FIG. 4, FIG. 5, FIG. 6, FIG. 7, FIG. 8, and FIG. 9 are flowchart diagrams illustrating an exemplary process for an EFT made during a videophone call and how the SMART card is charged for both the videophone call and the EFT.

In the present embodiment, the process begins at FIG. 3 at a start checkpoint. To begin, the method determines if the handset is off hook. If the handset is not off hook, the method returns to the start checkpoint. When the handset is taken off the hook, the method determines if a SMART card is inserted. If no SMART card has been inserted, the process returns to the start checkpoint. If a SMART card is inserted, the process checks for the secret code or PIN that identifies the SMART card as valid for use on the network. If the secret code is invalid, an invalid card message is displayed to the user, and the process is aborted and returns to the start checkpoint. If the secret code is valid, the stored value on the SMART card is determined. If the value stored on the SMART Card is insufficient to make a videophone call, an insufficient value message is displayed on the video payphone screen, and the process returns to the start checkpoint. If the value on the SMART card is sufficient to make a videophone call, the value of the SMART card is displayed on the video payphone screens and the caller is requested to dial a number. The process then waits for a predetermined time for the caller to press a numerical key. If no key is pressed within the allotted wait period, the call is aborted, and the process returns to the start checkpoint. If a key is pressed within the allotted time, the process continues to a checkpoint A.

The process continues in FIG. 4 at checkpoint A. Then the process determines if a Call Start key is pressed within a predetermined time after the last numerical key was pressed. If the Call Start key is not pressed within the allotted time, the call is aborted, and the process returns to the start checkpoint. If the Call Start key is pressed within the allotted time, the process determines if the called line is busy. If the called line is busy, the call is terminated. If the called line is not busy, the process continues, and the last four digits of the SMART card of the calling party are displayed on the called party video payphone screen. The process then waits a predetermined number of rings. If the call is not answered within the predetermined number of rings, the call is terminated. If the call is answered within the predetermined number of rings, the SMART card of the caller is debited a “flag fall” of one AOC unit when the SMART card receives the first AOC charge signal. A checkpoint B then checks that the SMART card is still inserted. If the SMART card is no longer inserted, the call is terminated. Then the process determines if the call is still connected. If the call is not connected, the call is terminated. If the call is still connected, the process continues to a checkpoint C.

The process continues in FIG. 5 at checkpoint C. If the call is still connected at checkpoint C, a start of call CDR is sent to a Central Office for call management purposes if this is the start of the call. If another AOC message is received, the process determines if the SMART card stored value is greater than one AOC unit. If the smart card value is greater than one AOC unit, the SMART card value is debited by one AOC unit, and a CDR message is sent to a Network Central Office. If the value of the SMART card is not greater than one AOC unit, a message is sent to the calling and called party screens advising that the call will be terminating in 1 minute. Then the call is terminated in one minute. Alternate embodiments may allow more or less time before terminating the call in this instance. In the present embodiment, if an AOC message is not received, the process determines if the EFT key has been pressed. If the EFT key has not been pressed, the process advances to a checkpoint H, shown by way of example in FIG. 9. If the EFT key is pressed, the process determines if there are sufficient stored value units to allow the videophone call to continue for a sufficient predetermined time for the call to continue through the EFT process and also have a minimum predetermined value available for the EFT. If the stored value is insufficient, an insufficient value for EFT message is displayed on the calling party videophone screen, and the process returns to checkpoint B. If the stored value is sufficient for EFT, an Enter EFT Amount message is displayed on the calling part), videophone screen. The process then determines if the keypad for the amount entered is complete. If the complete amount is not entered, the process checks for a predetermined timeout. If the amount is not completed in the allotted time, the process returns to checkpoint B. If the amount is inserted within the allotted time, the process continues to a checkpoint D.

The process continues in FIG. 6 at checkpoint D. Then the process determines if there is still sufficient value on the calling party SMART card. If there is not sufficient value, an Insufficient Funds Try Again message is displayed, and the process returns to checkpoint C. If there is sufficient value stored on the calling party SMART card, an insert SMART card message is sent to the called party videophone screen. The process then determines if the called party SMART card is inserted. If the called party SMART card is not inserted, a No SMART card at called party terminal message is displayed on the calling party videophone screen, and the process returns to checkpoint B. If the SMART card is inserted at the called party videophone, the process checks with the Internet Merchant Account server to determine if the inserted SMART card is valid. If the SMART card is not valid, a Card Invalid message is displayed on the called party videophone screen, and the process returns to checkpoint B. If the inserted SMART card is valid, the process then determines if the called party SMART Card has a sufficient ‘card enablement’ value stored to be able to continue with the EFT process. If the SMART card does not have sufficient value, an Insufficient Value to Receive EFT message is displayed on the called party videophone screen, and the process returns to checkpoint B. If the card has sufficient value, the process goes to a checkpoint E.

The process continues in FIG. 7 at checkpoint E. In the present embodiment, the process then checks with the IMA to determine if the calling and called party SMART cards previously had an incomplete transaction. If there was an incomplete transaction, a Retry last failed EFT message is displayed on the calling party videophone screen. Also at this point, the process determines if the calling party wishes to retry the last failed EFT. If not, a transaction cancelled message is sent to the IMA server. If the calling party wishes to retry the last failed EFT, the process advances to checkpoint G, shown by way of example in FIG. 8. If there was not an incomplete transaction during the previous call, the process determines if the called party SMART card has a sufficient ‘card enablement’ value stored to be able to continue with EFT process. If not, an Insufficient Value to Receive EFT message is displayed on the called party videophone screen, and the process returns to checkpoint B. If the value on the called party SMART card is sufficient, the process reaches a checkpoint F. After checkpoint F, an EFT in progress message is displayed on the called party videophone screen. The process then determines if the called party SMART card is still inserted. If not, an EFT aborted message is displayed on the calling and called party screens, and the process returns to checkpoint B. If the called party SMART card is still inserted, a Select Key # to make EFT is displayed on the calling party videophone screen. In alternate embodiments where different keys are used to initiate the EFT, this message will instruct the calling party to press the button that initiates the EFT. In the present embodiment, the process then determines if the calling party selects EFT by pressing the designated key. If so, the process continues to a checkpoint G. If not, an EFT aborted message is displayed on the calling and called party videophone screens, and the process returns to checkpoint B.

The process continues in FIG. 8 at checkpoint G. Here the process obtains a unique transaction number from the IMA server, then determines if the transaction number is written to the calling party SMART card. If not, a “Cannot Send EFT” call operator message is displayed on the calling party videophone screen. If the transaction number is written to the calling party SMART card, the process then determines if the transaction number is written to the called party SMART card. If the transaction number is not written to the called party SMART card, a “Cannot receive EFT” call operator message is displayed on the called party videophone screen. If the transaction number is written on the called party SMART card, the process debits from the calling SMART card the value of the EFT and credits the called party SMART card with the value of the EFT. The process then determines if the EFT is complete. If not, the process returns to checkpoint F. If the EFT is complete, an EFT complete message and transaction number is sent to the IMA server. Then an EFT complete and value transferred message is displayed on the calling and called party videophone screens, and the process returns to checkpoint B.

The process continues in FIG. 9 at checkpoint H where the process determines that the EFT button has not been pressed. At this point, the process determines if a Record This Still Screen from the current video key has been selected. If the Record This Still Screen key is selected, a freeze frame of the video in process is stored in the processor memory and the e-mail address where the freeze frame is to be delivered is requested. If an e-mail address is not entered, the process returns to checkpoint B, shown by way of example in FIG. 3. If the e-mail address is entered, a charge for the service may be debited from the SMART card, and the freeze frame and the e-mail address is sent to the Service Operator Server for later delivery. Then the process returns to checkpoint B. In the present embodiment, the system does not check for valid e-mail address entry, however, alternate embodiments may provide this service. If the Record This Still Screen from video key was not pressed, the process determines if a Start Recording Video key has been selected. If so, the process requests the e-mail address to where the video image will be streamed to. If the e-mail address is entered, the SMART card is debited a charge for the service, and the video begins streaming to Service Operator Server for later delivery, and the process returns to checkpoint B. If an e-mail address is not entered, the process returns to checkpoint B. Again, the present embodiment does not check for valid e-mail address entry.

If the Start Recording, This Video key was not selected, the process determines if a Make Fingerprint key is selected. If this key is not selected, the process returns to checkpoint B. If the Make Fingerprint key is selected, the called party is instructed to press the right hand index finger on the back of the videophone handset button while keeping the right hand visible to the video camera. In the present embodiment, this handset button comprises a fingerprint scanner. The called party is then instructed to repeat this with the left hand index finger In alternate embodiments, the called party may only be instructed to provide one fingerprint, or other fingers may be used such as, but not limited to the thumb. In the present embodiment, the process then determines if the fingerprints have been taken. If the fingerprints have not been taken, the process returns to checkpoint H. If the fingerprints have been taken, the fingerprints and video for activity duration are sent to the service operator server for storage and later retrieval, and the process returns to checkpoint B.

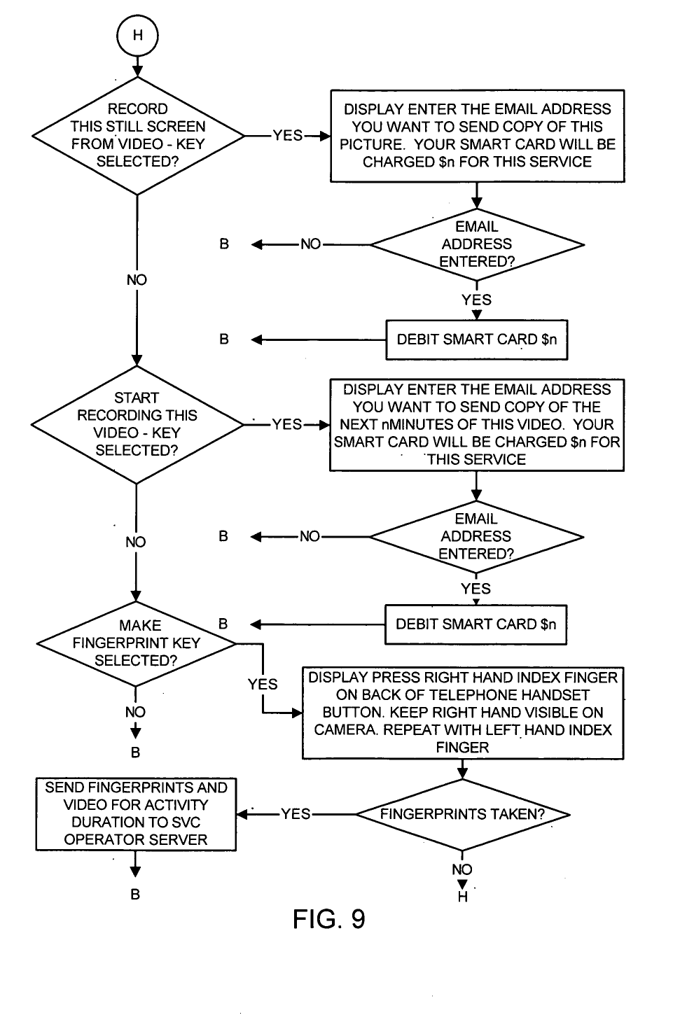

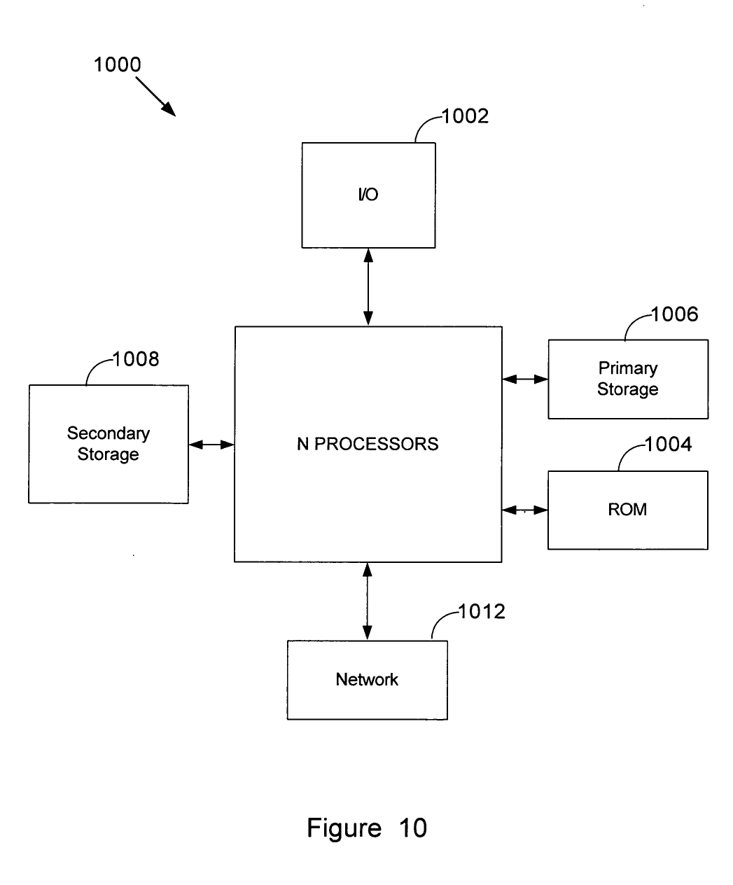

FIG. 10 illustrates a typical computer system that, when appropriately configured or designed, can serve as a computer system in which the invention may be embodied. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers and microprocessors such as programmable devices (e.g., CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner. Both of these primary storage devices may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device Such as a CD-ROM 914 may also pass data uni-directionally to the CPU.

CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection as shown generally at 912. With such a connections it is contemplated that the CPU might receive information from the network, or might output information to the network in the course of performing the method steps described herein.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, firmware, microcode and the like.

Having fully described at least one embodiment of the present invention, other equivalent or alternative methods of implementing person-to-person electronic fund transfer using video payphones according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method of transferring funds utilizing public access telecommunications terminals, the method comprising the steps of:
identifying two video payphones;
establishing a video phone call between said two video payphones;
connecting each of said video payphones to a central database providing secure EFT transfers;
identifying SMART cards associated with each of said video payphones;
writing an EFT transaction number to said SMART cards;
debiting a value from one of said SMART cards during said video phone call; and
crediting said value to another of said SMART cards during said video phone call.

2. The method as recited in claim 1, further comprising the step of validating said SMART cards with said central database.

3. The method as recited in claim 1, further comprising the step of reconstituting said debiting and said crediting in the event that said video phone call is interrupted.

4. The method as recited in claim 1, further comprising the step of enabling full motion video between said video payphones.

5. The method as recited in claim 1, further comprising the step of obtaining fingerprint and image verification from said video payphones.

6. The method as recited in claim 1, further comprising the step recording data and images for security purposes.

7. The method as recited in claim 1, further comprising the step of recording a portion of said video phone call.

8. The method as recited in claim 7, further comprising the step of sending said portion to an email address.

9. The method as recited in claim 7, further comprising the step of password protecting said portion for retrieval at a later time.

10. The method as recited in claim 1, further comprising the step of debiting one of said SMART cards a further value for maintaining said video phone call and processing the transferring of funds.

11. A system for transferring funds with SMART cards utilizing a telecommunications network, the system comprising:
a data communication network;
a dispenser for SMART cards connected to said data communication network, said dispenser configured to credit a SMART card;
a point-of-sale SMART card reader connected to said data communication network said point-of sale SMART card reader configured to debit a SMART card;
a merchant account server connected to said data communication network, said merchant account server in communication with said dispenser and said point-of-sale smart card reader, said merchant account server configured to control the value of SMART cards;
a video phone call using the telecommunication network;
a first video payphone connected to said data communication network and the telecommunications network, said first video payphone configured to initialize said video phone call;
a first SMART card reader connected to said first video payphone;
a second video payphone connected to said data communication network and the telecommunications network, said second video payphone configured to receive said video phone call;
a second SMART card reader connected to said second video payphone; and
a service operator server connected to said data communications network, said service operator server in communication with said first video payphone, said second video payphone and said merchant account server, said service operator server configured to debit and credit SMART cards during said video phone call thereby transferring the funds.

12. A computer program product residing on or being distributed across one or more computer readable mediums having a plurality of instructions stored thereon which, when executed by one or more associated processors, cause the one or more processors to:
identify two video payphones;
establish a video phone call between said two video payphones;
connect each of said video payphones to a central database providing secure EFT transfers;
write an EFT transaction number to SMART cards associated with each of said video payphones;
debit a value from one of said SMART cards during said video phone call; and
credit said value to another of said SMART cards during said video phone call.

13. The computer program product recited in claim 12, further causing the one or more processors to validate said SMART cards with said central database.

14. The computer program product recited in claim 12, further causing the one or more processors to reconstitute said debiting and said crediting in the event that said video phone call is interrupted.

15. The computer program product recited in claim 12, further causing the one or more processors to obtain fingerprint and image verification from said video payphones.

16. The computer program product recited in claim 12, further causing the one or more processors to record data and images for security purposes.

17. The computer program product recited in claim 12, further causing the one or more processors to record a portion of said video phone call.

18. The computer program product recited in claim 17, further causing the one or more processors to send said portion to an email address.

19. The computer program product recited in claim 17, further causing the one or more processors to password protect said portion for retrieval at a later time.

20. The computer program product recited in claim 12, further causing the one or more processors to debit one of said SMART cards a further value for maintaining said video phone call and processing the transferring of funds.
